(19) United States
(12) Patent Application Publication
(10) Pub. No.: US 2024/0250329 A1
(43) Pub. Date: Jul. 25, 2024

(54) SYSTEM AND METHOD FOR RECOVERING PLASITC FROM BATTERY MATERIALS

(71) Applicant: Li-Cycle Corp., Toronto (CA)

(72) Inventors: Timothy George Johnston, Toronto (CA); Christopher James Biederman, Hannon (CA); Michael Joseph Lovell, Kingston (CA); James Pettingill, Kingston (CA)

(21) Appl. No.: 18/564,890

(22) PCT Filed: May 26, 2022
(86) PCT No.: PCT/CA2022/050850

§ 371 Date: Nov. 28, 2023

Related U.S. Application Data
(60) Provisional application No. 63/194,350, filed on May 28, 2021.

(51) Int. Cl. H01M 10/54; B29B 17/02; B29B 17/04; C22B 7/00

(52) U.S. Cl. CPC H01M 10/54; B29B 17/02; B29B 17/04; C22B 7/005; B29B 2017/0244; B29B 2017/0268; B29B 2017/0289; B29B 2017/0468

(57) ABSTRACT

A method of separating plastic material from battery materials can include: a) receiving battery materials in an immersion comminuting apparatus; b) by carrying out at least a first size reduction of the battery materials under immersion to create a primary-reduced metal material, primary-reduced plastic material and liberating a first amount of a black mass material; c) extracting at least a primary plastics slurry from the primary comminuting apparatus, wherein the primary plastics slurry comprises a mixture of the primary-reduced plastic material, a portion of the primary-reduced metal material and a portion of the black mass material liberated by the immersion comminuting apparatus; and d) carrying out a further, second size reduction of the plastic slurry using a non-immersion comminuting apparatus that is downstream from the immersion comminuting apparatus.

### CROSS-REFERENCE TO RELATED APPLICATIONS

This application claims priority to and the benefit of co-pending U.S. provisional application Ser. No. 63/194,350 filed on May 28, 2021 entitled “SYSTEM AND METHOD FOR RECOVERING PLASTIC FROM BATTERY MATERIALS”, the entirety of which is incorporated herein by reference.

### FIELD OF THE INVENTION

In one of its aspects, the present disclosure relates generally to a system and method for processing batteries, including lithium-ion batteries (ternary, Lithium Iron Phosphorous batteries “LFP”, lithium solid state batteries “SSB” and the like) and other suitable batteries, and more particularly to systems and methods for recycling lithium-ion and the recovering of at least some lithium and/or other target materials, such as plastic, therefrom.

### INTRODUCTION

U.S. Pat. No. 9,312,581 relates to a method for recycling lithium batteries and more particularly batteries of the Li-ion type and the electrodes of such batteries. This method for recycling lithium battery electrodes and/or lithium batteries comprises the following steps: a) grinding of said electrodes and/or of said batteries, b) dissolving the organic and/or polymeric components of said electrodes and/or of said batteries in an organic solvent, c) separating the undissolved metals present in the suspension obtained in step b), d) filtering the suspension obtained in step c) through a filter press, e) recovering the solid mass retained on the filter press in step d), and suspending this solid mass in water, f) recovering the material that sedimented or coagulated in step e), resuspending this sedimented material in water and adjusting the pH of the suspension obtained to a pH below 5, preferably below 4, g) filtering the suspension obtained in step f) on a filter press, and h) separating, on the one hand, the iron by precipitation of iron phosphates, and on the other hand the lithium by precipitation of a lithium salt. The method of the invention finds application in the field of recycling of used batteries, in particular.

International Patent Application No. WO2005/101564 a method for treating all types of lithium anode batteries and cells via a hydrometallurgical process at room temperature. Said method is used to treat, under safe conditions, cells and batteries including a metallic lithium anode or an anode containing lithium incorporated in an anode inclusion compound, whereby the metallic casings, the electrode contacts, the cathode metal oxides and the lithium salts can be separated and recovered.

US Patent Publication No. 2010/0230518 discloses a method of recycling sealed batteries, the batteries are shredded to form a shredded feedstock. The shredded feedstock is heated above ambient temperature and rolled to form a dried material. The dried material is screen separating into a coarse fraction and a powder fraction and the powder fraction is output. A system for recycling sealed cell batteries comprises an oven with a first conveyor extending into the oven. A rotatable tunnel extends within the oven from an output of the first conveyor. The tunnel has a spiral vane depending from its inner surface which extends along a length of the tunnel. A second conveyor is positioned below an output of the rotatable tunnel.

U.S. Pat. No. 8,858,677 discloses a valuable-substance recovery method according to the present invention includes: a solvent peeling step (S3) of dissolving a resin binder included in an electrode material by immersing crushed pieces of a lithium secondary battery into a solvent, so as to peel off the electrode material containing valuable substances from a metal foil constituting the electrode; a filtering step (S4) of filtering a suspension of the solvent, so as to separate and recover the electrode material containing the valuable substances and a carbon material; a heat treatment step (S5) of heating the recovered electrode material containing the valuable substances and the carbon material, under an oxidative atmosphere, so as to burn and remove the carbon material; and a reducing reaction step (S6) of immersing the resultant electrode material containing the valuable substances into a molten salt of lithium chloride containing metal lithium, so as to perform a reducing reaction.

PCT patent publication no. WO2018/218358 discloses a process to recover materials from rechargeable lithium-ion batteries, thus recycling them. The process involves processing the batteries into a size-reduced feed stream; and then, via a series of separation, isolation, and/or leaching steps, allows for recovery of a copper product, cobalt, nickel, and/or manganese product, and a lithium product; and, optional recovery of a ferrous product, aluminum product, graphite product, etc. An apparatus and system for carrying out size reduction of batteries under immersion conditions is also provided.

US Patent Publication No. 2012/0312126 discloses a recovery method for recovering metals from lithium ion batteries using comparatively simple equipment and without using a cumbersome process. In said method, a positive electrode material from lithium ion batteries, containing lithium and a transition metal, is dissolved in an acidic solution, thereby generating lithium ions and ions of the transition metal in the acidic solution. Said acidic solution and a recovery liquid are then made to flow with an anion-permeable membrane interposed therebetween, causing the lithium ions to permeate from the acidic solution to recovery solution. Lithium ions are then recovered from the recovery liquid containing dissolved lithium ions.

### SUMMARY

Lithium-ion rechargeable batteries are increasingly powering automotive, consumer electronic, and industrial energy storage applications. An estimated 11+million tonnes of spent lithium-ion battery packs are expected to be discarded between 2017 and 2030, driven by application of lithium-ion batteries in electro-mobility applications such as electric vehicles.

Rechargeable lithium-ion batteries, including ternary, LFP, SSBs, and other types of batteries that may be processed using the teachings here, comprise a number of different materials within their battery cells.

A portion of the lithium-ion batteries can be described as ternary batteries, which can include lithium batteries that use lithium nickel cobalt manganate as the cathode and graphite as the anode. Other portions of the lithium-ion batteries can include lithium iron phosphate (LFP, or sometimes as a lithium ferrophosphate battery) batteries and these batteries may have a different composition than other types of lithium-ion batteries. For example, LFP batteries utilize LiFePO₄ as a cathode material, usually in combination with a graphitic carbon-based anode. LFP batteries typically include relatively lower amounts of metals, such as nickel and cobalt, than other types of lithium-ion batteries. As nickel and cobalt can be relatively valuable, the relatively low amounts of these metals in LFP batteries may make LFP batteries less desirable to recycle than other forms of batteries that would yield relatively larger amounts of these valuable metals.

Lithium-ion batteries are a type of rechargeable battery in which lithium ions drive an electrochemical reaction. Lithium has a high electrochemical potential and a high energy density. Lithium-ion battery cells have four key components: a. Positive electrode/cathode: including differing formulations of metal oxides or metal phosphate depending on battery application and manufacturer, intercalated on a cathode backing foil/current collector (e.g. aluminum)—for example: LiNixMnyCOzO2 (NMC); LiCoO2(LCO); LiFePO4 (LFP); LiMn2O4 (LMO); LiNiCoAlO2 (NCA); b. Negative electrode/anode: generally, comprises graphite intercalated on an anode backing foil/current collector (e.g. copper); c. Electrolyte: for example, lithium hexafluorophosphate (LiPF6), lithium tetrafluoroborate (LiBF4), lithium perchlorate (LiClO4), lithium hexafluoroarsenate monohydrate (LiAsF6), lithium trifluoromethanesulfonate (LiCF3SO3), lithium bis(bistrifluoromethanesulphonyl) (LiC₂F₆NO₄S₂), lithium organoborates, or lithium fluoroalkylphosphates dissolved in an organic solvent (e.g., mixtures of alkyl carbonates, e.g. Ci-C6 alkyl carbonates such as ethylene carbonate (EC, generally required as part of the mixture for sufficient negative electrode/anode passivation), ethyl methyl carbonate (EMC), dimethyl carbonate (DMC), diethyl carbonate (DEC), propylene carbonate (PC)); and d. Separator between the cathode and anode: for example, polymer or ceramic based.

“Black mass” as used herein refers to a combination of some of the components of rechargeable lithium-ion batteries (and/or other batteries) that can be liberated from within the cell during a processing step (such as a mechanical processing, disassembly and/or comminuting step) and includes at least a combination of cathode and/or anode electrode powders that may include lithium, nickel, cobalt, iron, phosphorous, manganese metal oxides. Materials present in rechargeable lithium-ion batteries include anode and cathode materials, as well as a suitable electrolyte (residual organic electrolyte such as Ci-C6 alkyl carbonates, such as ethylene carbonate (EC), ethyl methyl carbonate (EMC), dimethyl carbonate (DMC), diethyl carbonate (DEC), propylene carbonate (PC), and mixtures thereof) and possibly a solid separator which may be sulfide, oxide, ceramic or glass for SSBs. Depending on the type of batteries, or mixture of types of batteries that are being processed then the metals included in the black mass may be expected to include lithium, nickel, cobalt, iron, phosphorous, manganese.

Large format lithium-ion battery packs (e.g. in automotive and stationary energy storage system applications) are generally structured as follows: a. Cells: cells contain the cathode, anode, electrolyte, separator, housed in steel, aluminum, and/or plastic; b. Modules: multiple cells make up a module, typically housed in steel, aluminum, and/or plastic; and c. Battery pack: multiple modules make up a battery pack, typically housed in steel, aluminum, and/or plastic.

Several of the materials in a lithium-ion battery or battery pack can be recycled and may form separate outputs from an overall battery recycling process. For example, as noted above, PCT patent publication no. WO2018/218358 discloses a process to recover materials from rechargeable lithium-ion batteries, thus recycling them. The process involves processing the batteries into a size-reduced feed stream; and then, via a series of separation, isolation, and/or leaching steps, allows for recovery of a copper product, cobalt, nickel, and/or manganese product, and a lithium product; and, optional recovery of a ferrous product, aluminum product, graphite product, etc. An apparatus and system for carrying out size reduction of batteries under immersion conditions is also provided. However, while shredding the incoming battery materials under immersion conditions, such as described in PCT patent publication no. WO2018/218358, can have some benefits there can also be some challenges in processing the battery materials using this method.

For example, some components of the incoming battery materials, such as at least some of the plastics, packaging, insulation, connectors, fittings and the like, are less dense than the immersion liquid and therefore may tend to float within the comminuting apparatus housing. As the battery materials are comminuted (e.g. shredded in this example) the relatively heavier materials can sink toward the bottom of the comminuting housing, while the relatively lighter materials can float toward the top of the immersion liquid where they can be collected. These collected, floating materials typically include most of the plastics from the incoming battery materials and this extracted stream can be referred to as a plastic recovery stream. The material in the plastic recovery stream can provide a commercially useful output or product stream, as the collected plastic material can be sold to plastic recyclers.

Because the plastic material is floating in, and is mixed with the immersion liquid while the shredding is underway, the floating materials can be coated with, and possible retain some portions of the immersion liquid when they are withdrawn from the comminuting housing. For example, some of the plastic pieces may have cavities, crevasses or the like which can collect liquid, and most, if not all, of the exposed surfaces of the floating, plastic materials will be wet and coated with immersion liquid, and some of the immersion liquid may flow out via the plastic material outlet port (or other analogous apparatus through with the plastic material is extracted). The immersion liquid may have entrained within it a combination of some dissolved electrolyte material and some of the black mass material or other non-plastic materials. Therefore, extracting the floating, plastic material can also lead to a loss of some of the other desirable, target materials, such as the black mass. In some examples, it is believed that about 3-7% of the black mass material that is liberated from the battery materials by the comminuting apparatus can leave with the floating, plastic materials when they are extracted.

In some known systems, including described in PCT patent publication no. WO2018/218358, the plastic recovery stream can be washed after being withdrawn from the comminuting apparatus, and the filtrate from the washing process can be re-combined with other suitable portions of the overall recovery process. For example, the immersion liquid and any entrained black mass material that is washed from the materials in the plastics stream can be re-combined with the immersion liquid exiting the communising apparatus, or at a later stage in the process, so that any recovered black mass can be subjected to the same process steps and the original black mass. However, simply washing the plastic materials in the form they were originally extracted from the comminuting apparatus may not maximize recovery of the immersion liquid and entrained black mass, as the complex shapes of the plastic materials and surface tension of the liquids may tend to keep some of the black mass material with the plastics.

In addition to the immersion liquid and entrained black mass that can exit with the plastic materials, it has been discovered that some other components from within a battery pack may also be entangled with some of the plastic material and may then float up toward the top of the comminuting apparatus housing, rather than proceeding through the comminuting device/shredder and being properly processed. For example, it has been discovered that a battery pack that contacts the shredding apparatus (for example) can be partially shredded by its initial contact with the shredder blades, thereby separating some of the plastic housing materials from the rest of the pack, but that in some instances a battery cell, or fragments of a battery cell including non-shredded anode and cathode portions and/or other metal materials, can remain attached to the plastic housing material and can be pulled up with the plastic housing material before passing through the shredder blades. Such rogue battery cells and other metal can remain with the plastic material as it is extracted from the comminuting apparatus, and can end up mixed in with the plastic recovery stream. Having metal, battery cells and the like in the plastic recovery stream can be undesirable as it can contaminate the plastic material stream and may make it less useful for its intended purposes. It may also reduce the overall efficiency of the recycling process as the metals and battery cells in the plastic recovery stream may not further treated or captured.

Therefore, there remains a need for an improved system and/or process for extracting the plastic materials that are liberated from the battery materials during the size reduction process, such that the plastic material can be collected and sold or sent for further processing while other components of the battery materials, including metal by-products and the black mass material can be separated from the plastic for further processing.

To help address at least one of these shortcomings in the art, an improved method for processing the plastic recovery stream that is extracted from the primary comminuting apparatus/process can include some additional process steps, such as washing the plastic recovery stream and subjecting the plastic recovery stream to a second size reduction process in which the plastic recovery stream itself is further mechanically processed (such as by a plastic comminuting apparatus or the like) that is downstream from the primary comminuting apparatus. This secondary physical size reduction process can be done using a plastic comminuting apparatus and may help further break apart the plastic pieces, which may reduce or destroy the cavities, crevasses and other similar features that may tend to retain the immersion liquid, black mass and other metal components. This secondary physical size reduction process may also help ensure that any battery cells, partial cells or other material that is still potentially reactive within the plastic recovery stream is broken apart so as to be less reactive, and preferably to arrive at a condition that is similar to the condition of the metal components as they exit the primary comminuting apparatus.

Preferably, the plastic comminuting apparatus is not configured as a submerged-type comminuting apparatus (i.e. different than the primary comminuting apparatus) to help prevent the materials from floating away from the comminuting device or otherwise bypassing the comminuting process in the plastic comminuting apparatus. Because there is a chance that the plastic comminuting apparatus may encounter some battery cells or partial battery cells, the plastic comminuting apparatus can include a misting or spraying system that sprays a suitable liquid into its housing, but it is not full of an immersion liquid and is not intended to be a submerged shredding operation.

The process may also include an improved, mechanically assisted washing/separating process to help further separate the black mass and any other metals from the plastic material, along with further separation and washing stages.

To help achieve the desired mechanically assisted washing/separating process the plastic recovery stream may pass through a mechanical washing apparatus or tank that can include one or more suitable mechanical agitators that can physically engage and/or submerge the material flowing through the mechanical washing apparatus to help mix the material in tank and dislodged attached or entrained metals and other materials. The relatively heavier metals that are separated from the plastic materials can sink to the bottom of the mechanical washing apparatus where they can be recovered using a suitable mechanism (such as an auger or screw conveyer or the like), while the plastic material remains on the top of the liquid in the tank and can be extracted separately. The liquid within the mechanical washing apparatus tank can be water, clean immersion liquid, a process liquid taken from other parts of the overall recycling process (such as a clean buffer solution) or other suitable liquids.

In accordance with one broad aspect of the teachings described herein a method of separating plastic material from battery materials including the plastic material, may include the steps of:
a) receiving battery materials in an immersion comminuting apparatus comprising at least a first comminuting device submerged in an immersion liquid;
b) by carrying out at least a first size reduction of the battery materials under immersion conditions using the immersion comminuting apparatus thereby creating primary-reduced metal material, primary-reduced plastic material and liberating a first amount of a black mass material comprising anode and cathode powders from the battery materials, whereby sparking caused by the first size reduction is suppressed and heat generated by the first size reduction is absorbed by the immersion liquid;
c) extracting at least a primary plastics slurry from the primary comminuting apparatus, wherein the primary plastics slurry comprises a mixture of the size-reduced plastic material, a portion of the primary-reduced metal material and a portion of the black mass material liberated by the immersion comminuting apparatus;
d) carrying out a further, second size reduction of the plastic slurry using a non-immersion comminuting apparatus that is downstream from the immersion comminuting apparatus and comprises at least a first non-submerged comminuting device, thereby creating at least secondary-reduced metal material and secondary-reduced plastic material; and
e) extracting a secondary plastic stream from the non-immersion comminuting apparatus, the secondary plastic stream comprising the secondary-reduced metal material, secondary-reduced plastic material.

The method may include spraying the first non-submerged comminuting device with a spray liquid while conducting the second size reduction, whereby the second size reduction is carried out under wet, but non-submerged conditions.

Sparking caused by the second size reduction may be suppressed and heat generated by the second size reduction may be absorbed by the spray liquid.

The spray liquid may include at least one of sodium hydroxide, calcium hydroxide, lithium hydroxide and the immersion liquid.

The primary plastic slurry may include at least partially intact battery materials that did not pass through the first comminuting device. The second size reduction may liberate a second amount of the black mass material from the at least partially intact battery materials in the primary plastic slurry.

The secondary plastic stream may include the black mass material liberated by the non-immersion comminuting apparatus.

The method may include processing the secondary plastic stream to separate at least some of the secondary-reduced plastic material from the secondary-reduced metal material and black mass material remaining in the secondary plastic stream using a plastic separator, thereby producing separated plastic material.

The plastic separator may include a separator tank containing a liquid configured for floating the secondary-reduced plastic material and allowing the secondary-reduced metal material to and black mass material remaining in the secondary plastic stream precipitate.

The separator tank may include at least one movable, submersion agitator configured to contact and temporarily submerge portions of the secondary plastic stream floating on the liquid in the separator tank to enhance precipitation of the secondary-reduced metal material and the black mass material remaining in the secondary plastic stream.

The method may include post-washing the separated plastic material exiting the plastic separator using a post-wash apparatus downstream from the plastic separator to remove black mass material that remained on the secondary-reduced plastic material when it exited plastic separator.

The method may include pre-washing the primary plastics slurry exiting the immersion comminuting apparatus, using a pre-washing apparatus disposed between the immersion comminuting apparatus and the non-immersion comminuting apparatus, to separate at least some of the black mass material from the size-reduced plastic pieces before the plastic slurry reaches the non-immersion comminuting apparatus.

The pre-washing apparatus may include a solid/liquid separator.

The second size reduction may be carried out at substantially atmospheric pressure and at less than 70 deg. C.

The first size reduction may be carried out when the immersion liquid is at an operating temperature that is less than 70 degrees C.

The immersion liquid may include at least one of sodium hydroxide, calcium hydroxide, and lithium hydroxide.

The first size reduction may be carried out when the immersion liquid is at substantially atmospheric pressure.

At least some of the battery materials received in step 1a) may be in at least a partially charged state.

The method may include extracting a metals outlet stream from the immersion comminuting apparatus. The metals outlet stream may include a majority of the black mass material liberated by the immersion comminuting apparatus.

In accordance with another broad aspect of the teachings described herein, a system for recovering plastic material from battery materials may include an immersion comminuting apparatus having at least a first comminuting device submerged in an immersion liquid configured to carry out at least a first size reduction of the battery materials under immersion conditions thereby creating primary-reduced metal material, primary-reduced plastic material and liberating a first amount of a black mass material comprising anode and cathode powders from the battery materials. Sparking caused by the first size reduction may be suppressed and heat generated by the size reduction may be absorbed by the immersion liquid. A plastic recovery stream may exit a plastic outlet of the first communising device and may include a primary plastics slurry that includes a mixture of the size-reduced plastic material, a portion of the primary-reduced metal material and a portion of the black mass material liberated by the immersion comminuting apparatus. A non-immersion comminuting apparatus may include at least a first non-submerged comminuting device disposed downstream from the immersion comminuting apparatus to receive a primary plastics slurry. The non-immersion comminuting apparatus may be configured to carry out a second size reduction on the primary plastics slurry, thereby creating at least secondary-reduced metal material and secondary-reduced plastic material. A secondary plastic stream may exit the non-immersion comminuting apparatus and may include the secondary-reduced metal material, secondary-reduced plastic material.

The non-immersion comminuting apparatus may include a spraying apparatus configured to spray the first non-submerged comminuting device with a spray liquid while conducting the second size reduction, whereby the second size reduction is carried out under wet, but non-submerged conditions.

Sparking caused by the second size reduction may be suppressed and heat generated by the second size reduction may be absorbed by the spray liquid.

The spray liquid may include at least one of sodium hydroxide, calcium hydroxide, lithium hydroxide and the immersion liquid.

The primary plastic slurry may include at least partially intact battery materials that did not pass through the first comminuting device. The second size reduction may liberate a second amount of the black mass material from the at least partially intact battery materials in the primary plastic slurry.

The secondary plastic stream may include the black mass material liberated by the non-immersion comminuting apparatus.

The system may include a plastic separator fluidly connected downstream from the non-immersion comminuting apparatus and may be configured to process the secondary plastic stream to separate at least some of the secondary-reduced plastic material from the secondary-reduced metal material and black mass material remaining in the secondary plastic stream using, thereby producing separated plastic material.

The plastic separator may include a separator tank containing a liquid configured for floating the secondary-reduced plastic material and may allow the secondary-reduced metal material to and black mass material remaining in the secondary plastic stream precipitate.

The separator tank may include at least one movable, submersion agitator configured to contact and temporarily submerge portions of the secondary plastic stream floating on the liquid in the separator tank to enhance precipitation of the secondary-reduced metal material and the black mass material remaining in the secondary plastic stream.

The system may include post-washing the separated plastic material exiting the plastic separator using a post-wash apparatus downstream from the plastic separator to remove black mass material that remained on the secondary-reduced plastic material when it exited plastic separator.

The system may include a pre-washing apparatus fluidly connected between the immersion comminuting apparatus and the non-immersion comminuting apparatus. The pre-washing apparatus may be configured to receive the primary plastics slurry exiting the immersion comminuting apparatus and to separate at least some of the black mass material from the size-reduced plastic pieces before the plastic slurry reaches the non-immersion comminuting apparatus.

The pre-washing apparatus may include a solid/liquid separator.

The second size reduction may be carried out at substantially atmospheric pressure and at less than 70 deg. C.

The first size reduction may be carried out when the immersion liquid is at an operating temperature that is less than 70 degrees C.

The immersion liquid may include at least one of sodium hydroxide, calcium hydroxide and lithium hydroxide.

The first size reduction may be carried out when the immersion liquid is at substantially atmospheric pressure.

At least some of the battery materials processed by the immersion comminuting apparatus are in at least a partially charged state.

The immersion comminuting apparatus may include a metals outlet through which a metals outlet stream comprising a majority of the black mass material liberated by the immersion comminuting apparatus may exit the immersion comminuting apparatus.

In addition to processing lithium-based batteries, the systems and methods described herein may also be used to process other types of battery materials, including lead acid batteries, alkaline batteries, nickel metal hydride (NiMH) batteries, nickel cadmium (NiCAD) batteries and the like.

### BRIEF DESCRIPTION OF THE DRAWINGS

Embodiments of the present invention will be described with reference to the accompanying drawings, wherein like reference numerals denote like parts, and in which:

FIG. 1 is one schematic example of a system for recovering plastic from battery materials,

FIG. 2 is one schematic example of a system for recovering plastic from battery materials;

FIGS. 3a and 3b are schematic representations of one example of a plastic separator; and

FIG. 4 is one example of a method of separating plastic material from battery materials.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

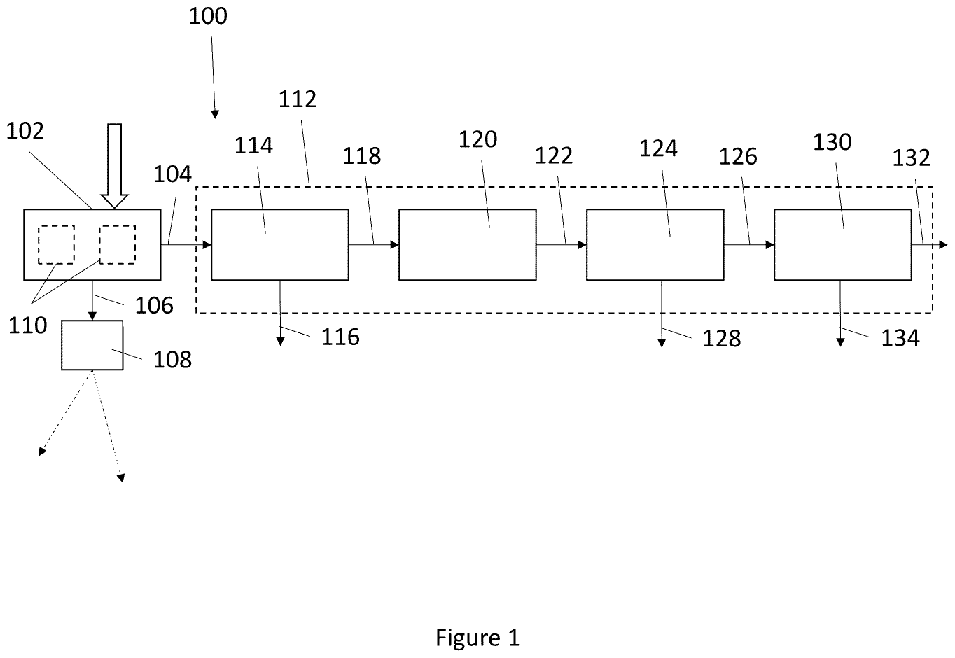

Referring to FIG. 1, one schematic representation of an example of a system 100 for recovering plastic materials from batteries is illustrated. This system 100, in the example illustrated, is configured to recover plastics from lithium-ion batteries as described herein, and may be a portion of a larger overall material recovery process that also includes upstream and downstream processing steps (including hydrometallurgical processing steps). While this system 100 and its use to primarily recover the plastic from the incoming battery materials will be described in detail as an example of the present teachings, other embodiments of the system may also be configured to recover black mass and other useful product streams, and may be used on other types of lithium batteries and other batteries that do not contain lithium.

In this example, the system 100 includes a primary size reduction apparatus 102 that is configured to receive incoming batteries and/or battery materials. One example of a suitable apparatus that can be used as part of the apparatus 102 can be described as an immersion comminuting apparatus that can include a housing that has at least one battery inlet through which battery materials can be introduced into the housing.

The size reduction apparatus 102 preferably has at least a first, submergible comminuting device that can be disposed within the housing and is preferably configured to cause a first or primary size reduction of the battery materials to form reduced-size battery materials (which can include a mixture of size-reduced plastic material, size-reduced metal material and other materials) and to help liberate metal, including lithium or other metals depending on the type of battery being processed, and cathode materials and other metals from within the battery materials.

The size reduction apparatus may include two or more separate comminuting apparatuses in some examples, and each immersion comminuting apparatus may itself have one, two or more submerged comminuting devices contained therein and arranged in series, such that the size reduction apparatus may include two or more size-reduction steps in series, and may allow for intervening process steps between the size-reduction steps. For the purposes of the teachings herein, and for distinguishing between the secondary size-reduction that is performed on the plastics slurry/stream as described herein, the overall operations of the first, or primary size reduction apparatus can be described as a first or primary size reduction process, where generally raw or unprocessed incoming battery materials can enter the size reduction apparatus 102 and then one or more streams of size-reduced material that are sent to other process steps are obtained. The content of these post-size reduction apparatus 102 material can be described has having size-reduced or primary-reduced materials (i.e. fragments of the incoming battery materials) regardless of the number of internal size-reduction steps are employed in the size reduction apparatus 102.

For example, a size reduction apparatus 102 with a single shredding stage can receive incoming battery materials, conduct at least a first size reduction and produce primary-reduced materials that are sent for further processing. Similarly. a size reduction apparatus 102 that includes two separate immersion comminuting apparatuses arranged in series (each with at least one submerged comminuting device) and with some product take-off streams between them can also be described as receiving the incoming battery materials, conducting at least a first size reduction process and producing primary-reduced materials for the purposes of the teachings herein.

The immersion material, preferably an immersion liquid (but optionally a granular solid in some examples), may be provided within the housing of the immersion comminuting apparatus and preferably is configured to submerge at least the first comminuting device, and optionally may also cover at least some of the battery materials. The first size reduction of the battery materials using this apparatus can thereby be conducted under the immersion material (and under immersion conditions) whereby the presence of oxygen is supressed, absorption of heat and the chemical treatment of electrolyte by the immersion liquid. This may also cause the electrolyte materials, the black mass material and the reduced-size plastic and metal materials to become at least partially entrained within the immersion liquid to form a blended material or slurry. Some of the size-reduced material may also float on the immersion liquid. The immersion comminuting apparatus may therefore include a plastics outlet that is positioned toward its upper end and through which a plastics slurry can be extracted, and one or more metal outlets that are provided toward the lower end of the immersion comminuting apparatus and through which a metals slurry/outlet stream can be extracted. The metals slurry/outlet stream will likely include a majority of the metal pieces and a mixture of the metallic foils, the cathode materials, electrolyte and immersion material. The plastics slurry may contain a majority of the plastic and other buoyant material, but can also include a relatively small amount of the size-reduced metal, black mass material and electrolyte materials as described herein.

The incoming battery materials can be large format batteries or small format batteries, and can include complete battery cells, battery packs and other combinations of batteries, packaging, housings and the like. Large format lithium-ion batteries can be, for example, batteries measuring from about 370 mm×about 130 mm×about 100 mm to about 5000 mm×about 2000 mm×about 1450 mm in size (or volume equivalents; expressed as a rectangular prism for simplification of geometry), and can include electric car batteries or batteries used in stationary energy storage systems. Small format batteries can be, for example, batteries measuring up to about 370 mm×about 130 mm×about 100 mm in size (or volume equivalents; expressed as a rectangular prism for simplification of geometry), and can include portable batteries such as those from cell phones, laptops, power tools or electric bicycles. Large format batteries are generally known in the art to be larger than small format batteries. In another embodiment, the battery materials can comprise battery parts as opposed to whole batteries or battery packs; however, the apparatus, system, and process described herein may be particularly suited to processing whole batteries.

The primary size reduction apparatus 102 is preferably configured so that it can produce at least two, and optionally more output streams that include different components that have been liberated from the incoming battery materials. For example, the a primary size reduction apparatus 102 is preferably configured so that plastics can be withdrawn via at least one plastic recovery stream and non-plastics, including optionally the black mass material and other materials, such as copper and aluminium foils, can be withdrawn via at least one non-plastic or metals recovery stream. This can allow the plastic material to be processed generally separately from the metal or other non-plastic materials.

The size reduction apparatus is preferably configured so that it can complete at least the first size reduction step on in the incoming battery materials under immersion conditions. That is, a size reduction apparatus can have a housing containing a least one comminuting device (e.g. a shredder) that is submerged in a suitable immersion liquid (or other suitable immersion material) while shredding the battery materials. The size reduction apparatus can be any suitable apparatus, including those described herein and those described in PCT patent publication no. WO2018/218358, U.S. Provisional Patent Application No. 63/122,757, and PCT patent application no. PCT/CA2021/050266, each of which are incorporated herein by reference.

The immersion liquid used in the described embodiments may be basic and is preferably at least electrically conductive to help absorb/dissipate any residual electric charge from the incoming battery materials. The immersion liquid may be selected such that it reacts with lithium salt (e.g. LiPF₆) that may be produced via the liberation of the electrolyte materials during the size reduction process, whereby the evolution of hydrogen fluoride during the size reduction is inhibited. The immersion liquid within the housing of the primary immersion apparatus 102 may preferably be at an operating temperature that is less than 70 degrees Celsius to inhibit chemical reactions between the electrolyte materials and the immersion liquid, and optionally the operating temperature may be less than 60 degrees Celsius. The immersion comminuting apparatus can be configured so that the immersion liquid is at substantially atmospheric pressure (i.e. less than about 1.5 bar) when the system is in use, which can simplify the design and operation of the apparatus.

In some examples, the immersion liquid may be at least one of water and an aqueous solution. The immersion liquid may have a pH that is greater than or equal to 8, and optionally may include at least one of sodium hydroxide, calcium hydroxide, and lithium hydroxide. The immersion liquid may include a salt, whereby the immersion liquid is electrically conductive to help at least partially dissipate a residual electrical charge within the battery materials that is released during the size reduction. The salt may include at least one of sodium hydroxide, calcium hydroxide and lithium hydroxide.

Particles that are liberated from the battery materials by the comminuting apparatus 102 during the first size reduction may be captured and entrained within the immersion liquid and may be inhibited from escaping the housing into the surrounding atmosphere. The first comminuting device may be configured as a shredder that is configured to cause size reduction of the battery materials by at least one of compression and shearing. The black mass material obtained using these processes, including at least some residual amounts of the immersion liquid and any electrolytes entrained therein can form the black mass feed materials as described herein. In these configurations, the size reduction can be conducted on batteries that have at least some partial or residual charge, and optionally on batteries that are more than 10%, 20%, 30%, 40%, 50%, 60%, 70%, 80%, 90% charged and may be fully charged. Preferably, the primary size reduction process can be executed without having to first discharge the incoming batteries or otherwise reduce the charge state of the incoming batteries, because the immersion conditions can help suppress the heat generation and sparking that would otherwise be problematic when shredding batteries with a residual electrical charge. This can help simplify the method and can eliminate the need for a separate discharging step prior to the size reduction in the processes.

In the illustrated example, the primary size reduction apparatus 102 is configured so that it can carry out a first size reduction and shred the incoming battery materials via at least one shredding/comminuting device submerged in a suitable immersion liquid, whereby plastics and other relatively light materials will float in the immersion liquid and metals and other relatively heavy materials will tend to sink. The plastic materials can be skimmed or otherwise extracted as a plastics slurry from the shredding/comminuting device via a plastic recovery stream 104. As noted above, the plastics slurry in the plastic recovery stream can include a combination of size-reduced plastic material along with some of the immersion liquid and some metals (including black mass and/or copper and aluminum foils) that are entrained with the liquid and/or stuck to or within the plastic pieces. The materials as shredded via this first comminuting apparatus 102 can also be described as primary-reduced metal material, primary-reduced plastic material herein.

The primary sized-reduced battery materials can form a metals outlet stream 106 that exits the primary size reduction apparatus 102, and can include a majority of the black mass materials liberated in the primary size reduction apparatus 102 and/or copper and aluminum foils that have been separated from the plastics. For example, the metals slurry exiting via the metals outlet stream 106 may include at least 60%, 70%, 80%, 90%, 95% wt. or more of the liberated black mass materials, which may be advantageous if the metals outlet stream 106 is to be sent for further processing to separate the metals and preferably recover at least some of the lithium from the black mass.

For example, the metals outlet stream 106 exiting the primary disassembly apparatus 102 can optionally be sent through a hydrometallurgical processing system 108 (or any other suitable processing system) that can be used to help separate lithium metal from foils and other cathode material that is present in the size-reduced battery materials, as well as extract other desired product streams and materials (illustrated using dashed arrows in FIG. 1). The hydrometallurgical processing system 108 can include any suitable processes and systems, including leaching, precipitation, filters and other operations that can help separate and extract the various target products, including utilizing the processes and systems described in in PCT patent publication no. WO2018/218358, U.S. Provisional Patent Application No. 63/122,757, and PCT patent application no. PCT/CA2021/050266, each of which are incorporated herein by reference.

Conversely, a relatively smaller, minority amount of the liberated black mass material, such as less than 15%, or less than about 10%, 9%, 8%, 7%, 6%, 5%, 4%, 3%, 2% or 1% wt. of the expected/liberated black mass material may be captured in the plastics slurry. As this black mass material that escapes via the plastics slurry may be commercially valuable, it may be advantageous to recover at least some of the black mass material that escapes the primary comminuting apparatus 102 via the plastics slurry.

The size reduction apparatus 102 may have any suitable configuration and may include one, two or more physical/mechanical processing steps (in two or more separate apparatuses or physical structures shown schematically as sub-apparatuses 110 in FIG. 1) that can be help convert the incoming battery materials to a suitable size-reduced battery materials that can then form at least part of the blended metals material stream 106 that exits the size reduction apparatus 102 for further processing. For example, the size reduction apparatus 102 may include one or more suitable comminuting apparatus that can grind/shred the battery materials, thereby liberating materials from within the battery cells and reducing the physical size of the battery materials. A single stage comminuting apparatus may be configured so that the battery materials only pass through one comminuting device 110 before exiting the apparatus 102, although there may be several comminuting devices arranged in parallel within a single housing/apparatus or in separating housings/apparatuses to accommodate a desired volume of incoming battery materials. Alternatively, the apparatus 102 may include two or more comminuting devices 110 arranged in series, such that the incoming battery materials undergo at least two, and optionally more, size reduction processes in series. It is also possible that in some examples of the systems and processes described herein that other materials could be added as part of the disassembly processes and one or more chemical or physical reactions could also occur within the apparatus 102.

Whether a single or multiple processing steps are used within the apparatus 102, and/or whether any other processes or reactions occur, the metal materials exiting the apparatus 102 via stream 106 can be further processed via the hydrometallurgical processing system 108 and the plastics slurry extracted via the plastic recovery stream 104 can be described as the primary plastics slurry that is understood to include both plastic material pieces as well as the mixture of immersion liquid, black mass material and other inadvertently captured metals and cells as used herein.

After leaving the size reduction apparatus 102, the plastics slurry in the plastic recovery stream 104 can be processed via a plastic recovery circuit 112 that can include multiple sub-steps and assemblies, as illustrated schematically in FIG. 1. In this example, the plastic recovery circuit 112 receives the plastics slurry in the plastic recovery stream 104 exiting the size reduction apparatus 102 and directs the plastic recovery stream 104 to a pre-wash apparatus 114, which can include any suitable solid/liquid separator device such as a screen, where the material in the plastic recovery stream 104 can be sprayed with a suitable liquid, such as used or unused immersion liquid, water or other solutions, so that at least some of the black mass, immersion liquid and entrained electrolyte material can be washed off of the larger plastic pieces, and other material pieces in the primary plastics slurry.

This first washing process will generally not be sufficient to dislodge or separate large metal material pieces from the plastics slurry, such as intact or partially intact battery cells that are mixed in the plastic recovery stream 104 because such material may be about the same size as the plastic pieces and/or may be connected to a plastic piece such that they will not pass through the screen. The filtrate 116 from the a pre-wash apparatus 114 can be discarded, sent for further processing and/or recycled upstream into the process (such as being re-introduced into the size reduction apparatus 102). The remaining solid plastic and metal material in the plastics slurry can exit the pre-wash apparatus 114 as a washed stream 118. The pre-wash apparatus 114 is optional, and can be omitted in some examples of the plastic recovery circuit 112.

In the illustrated example, the washed plastics slurry stream 118 (or the untreated plastics slurry in embodiments that do not include the pre-wash apparatus 114) is then directed to a suitable plastic comminuting apparatus 120 that is configured to conduct a subsequent, second size-reduction on the incoming mixed plastic and metal material in the plastics slurry.

The plastic comminuting apparatus 120 can include a respective housing and any suitable, secondary comminuting device (or multiple comminuting devices) that can break the relatively large pieces in the incoming plastics slurry into smaller pieces, and can include a dual or quad-shaft shredding device having a pair(s) of contra-rotating, intermeshing shredding rollers with suitable blades to cause the desired size reduction in the battery materials, or other suitable device, that can shred the plastic slurry using primarily shear forces. The plastic comminuting apparatus 120 can have a housing that contains the shredding rollers, has an inlet to receive the plastic slurry and at least one outlet via which a size-reduced plastic slurry (e.g. a plastic slurry in which the plastic and metal pieces have been subjected to a further size reduction and are smaller than in the plastic slurry exiting the primary comminuting apparatus 102) can be extracted.

Unlike the primary comminuting apparatus 102, the plastic comminuting apparatus 120 is preferably configured as a non-immersion comminuting apparatus in which its shredding blades (or other suitable comminuting device) are not submerged in an immersion liquid when in use. This may be helpful because the process stream that is being sent to the plastic, non-immersion comminuting apparatus 120 includes materials that were generally buoyant in the immersion liquid contained in the primary comminuting apparatus 102 to a degree that they did not pass all the way through the comminuting device and were skimmed from the upper portion/surface of the immersion liquid. If this comminuting device were also submerged in the same immersion liquid then it is likely that at least some of the incoming materials would again float on the liquid, and may not be properly processed by this comminuting device. Therefore, the plastic comminuting apparatus 120 is configured as a non-immersion comminuting apparatus where the incoming, relatively buoyant materials will not float away from the shredding cutters.

If desired, the plastic comminuting apparatus 120 can including a spraying apparatus that can spray a suitable spray liquid onto the shredding blades of the non-immersion comminuting device and/or incoming material while the apparatus 120 is in use (to help reduce dust, dissipate heat, inhibit of-gassing etc.). The spray liquid can include used or unused immersion liquid, water or other suitable liquids.

Processing the plastic slurry via the plastic comminuting apparatus can produce a size-reduced, secondary plastic stream 122, which may be a slurry and/or have a combination of solid material and at least some liquid or moisture content, that can be extracted from the apparatus 120. In addition to relatively smaller plastic and metal pieces, the size-reduced plastic slurry may also include electrolyte, black mass materials that was separated from the plastic and metal pieces via the shredding and may also include a second amount of newly released electrolyte, black mass materials that is first liberated when any partially or completely intact battery cells were ruptured by the plastic comminuting apparatus 120 (i.e. having not been ruptured via the primary comminuting apparatus 102).

Having been processed through the plastic comminuting apparatus 120, the size-reduced, secondary plastic stream 122 and can be further processed to help separate the smaller plastic pieces from the metal pieces, black mass and electrolyte materials that are mixed within the sized-reduced plastic slurry 122. This post-second-size-reduction separation can be done using any suitable separator 124 that is downstream from and fluidly connected to the plastic comminuting apparatus 120. The separator 124 can be any suitable device that is operable to help separate the size-reduced plastic pieces from the size-reduced metal pieces, black mass and electrolyte.

Preferably, the separator 124 can include a separator tank that can receive the size-reduced plastic slurry. The separator tank can hold a suitable liquid, such as the immersion liquid (used or unused), water, the spray liquid used to spray the interior of the plastic comminuting apparatus 120 or other suitable composition. As the size-reduced plastic slurry enters the separator tank heavy material, like the metal pieces and black mass may tend to sink while the lighter plastic may remain on the surface. Optionally, the separator tank can include one or more mechanical agitators positioned to engage the material floating on the surface of the liquid within the separator tank to agitate and preferably temporarily re-submerge the floating material, for example as it travels along the tank. This may help dislodge any embedded metal material and/or to help wash off any adhering black mass and/or electrolyte materials from the plastic in the secondary plastic stream. The separator tank can optionally include two or more such mechanical agitators arranged in series.

The separator 124 is preferably configured to have a plastics outlet toward the top of the tank where a relatively purer stream of separated plastic material 126 can be extracted, and a metals outlet toward the bottom of the tank through which any of the separated, precipitated metals and other non-plastic materials can be extracted as a metals stream 128. The metals stream 128 may be subjected to any desired processing to help recover any target metals and/or black mass material that was separate from the size-reduced plastic slurry via the separator 124 and may be routed into the hydrometallurgical process 108 or other suitable process.

Optionally, instead of the separator tank described herein, the separator 124 can include any other suitable device(s), such as a filter, precipitation tank, screen, magnetic separator or the like.

Optionally, the separated plastic material 126 exiting the separator 124 can be subjected to a second washing/screening process using a post-wash apparatus 130, that can be any suitable apparatus and may be generally the same as, or different than, the pre-wash apparatus 114. In this example, the post-wash apparatus 130 can include a screen where the separated plastic material 126 can be sprayed with a suitable liquid to help remove remaining black mass, electrolyte or other material that may have remained on the separated plastic material 126 when it exited the separator 124. The output plastic material 132 exiting the post-wash apparatus 130 can then exit the plastic circuit 112 and be collected and packaged for sale or further processing. If a post-washing apparatus 130 is not used, the separated plastic material 126 may also serve as the output plastic material 132. The filtrate from the post-wash apparatus 130 can exit as filtrate stream 134, and can be disposed of, further processed and/or recycled into the processes described herein.

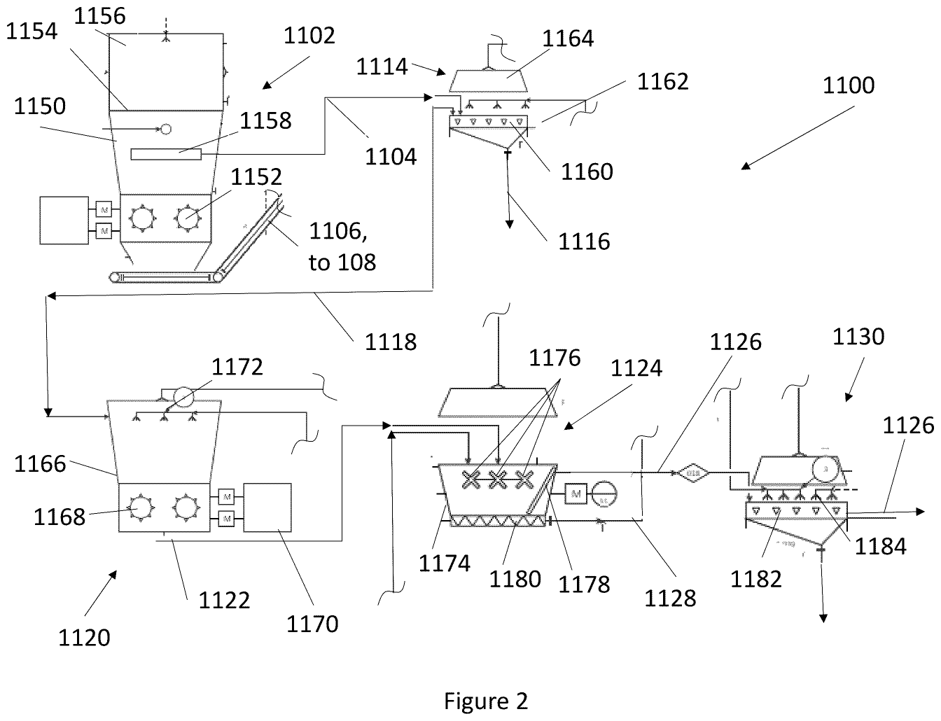

Referring to FIG. 2, another schematic example of a system 1100 for recovering plastic materials from batteries is illustrated. The system 1100 is analogous to system 100, and like features are annotated using like reference characters indexed by 1000.

In this example, the system 1100 includes a primary size reduction apparatus 1102 that includes an immersion comminuting apparatus configured to receive incoming batteries and/or battery materials. In this example, the apparatus 1102 includes a housing 1150 that is sized and configured to contain at least one submerged comminuting device, and optionally two or more comminuting devices arranged optionally in parallel and/or in series with each other. The first submerged comminuting device in this example is a dual-shaft shredding device 1152 having a pair of contra-rotating, intermeshing shredding rollers with suitable blades to cause the desired size reduction in the battery materials.

The housing 1150 includes a battery inlet 1154 through which battery materials can be introduced into the housing. In this example, the battery inlet 1154 is provided toward the upper end of the housing 1150 and includes an opening in the upper wall of the comminuting apparatus 1102 and a feed guide in the form of a hopper 1156 that is aligned with and extends from the opening. In this arrangement battery materials in the hopper can be fed by gravity into the housing 1150. The housing 1150 can be filled with a suitable immersion liquid, some examples of which are described herein, so that the dual-shaft shredding device 1152 is submerged while the apparatus 1102 is in use.

In this arrangement, as the incoming battery materials are shredded by the dual-shaft shredding device 1152, plastic material, along with other buoyant materials and any metals, black mass and other substances mixed therewith, can float within the housing 1150 can be capture by an extractor 1158, which can be hood or other collection device that can function as a plastics outlet. The captured material can then be conveyed from the apparatus 1102 as the primary plastic slurry in the plastic recovery stream 1104 as described herein. While some black mass may be mixed in the plastics slurry, the majority of the black mass and other non-buoyant materials can pass through the dual-shaft shredding device 1152 and exit out of a suitable metals outlet at the bottom of the apparatus 1102 as the metals outlet stream 1106 for further processing.

The size reduction apparatus 1102 may have any suitable configuration and may include one, two or more physical/mechanical processing steps that can be help convert the incoming battery materials to a suitable size-reduced battery materials that can then form at least part of the blended metals material stream 1106 that exits the size reduction apparatus 1102 for further processing. For example, the size reduction apparatus 1102 may include two or more separate, dual-shaft shredding devices like 1152 arranged within a common housing 1150. Alternatively, the apparatus 1102 may include two or more of the illustrated assemblies arranged in series (e.g. two or more housings 1150 each with respective, submerged dual-shaft shredding devices like 1152 and other features.

After leaving the size reduction apparatus 1102, the primary plastics slurry in the plastic recovery stream 1104 can be processed via a plastic recovery circuit that can include multiple sub-steps and assemblies, as illustrated schematically in FIG. 2. In this example, the plastic recovery circuit receives the primary plastics slurry in the plastic recovery stream 1104 exiting the size reduction apparatus 1102 and directs the plastic recovery stream 1104 to a pre-wash apparatus 1114, which includes a separator device in the form of a screen 1160 where the material in the plastic recovery stream 1104 can position and then sprayed with a suitable liquid via a spraying apparatus 1162 that includes nozzles that are fluidly connected to a washing fluid reservoir. A ventilation hood 1164 can be positioned above the screen 1160 to capture any escaping fumes, mist and the like. When using the pre-wash apparatus 1114 at least some of the black mass, immersion liquid and entrained electrolyte material can be washed off of the larger plastic pieces, and other material pieces in the plastics slurry in the stream 1104. The filtrate 1116 from the a pre-wash apparatus 1114 can be discarded, sent for further processing and/or recycled upstream into the processes described herein. The remaining solid plastic and metal material in the plastics slurry can exit the pre-wash apparatus 1114 as a washed plastic slurry stream 1118.

In this example, the washed plastics slurry stream 1118 (or the untreated plastics slurry in embodiments that do not include the pre-wash apparatus 1114) is directed to a suitable non-immersion, plastic comminuting apparatus 1120 that is configured to conduct a subsequent size-reduction on the incoming mixed plastic and metal material in the plastics slurry.

The plastic comminuting apparatus 1120 in this example is a non-immersion comminuting apparatus with a housing 1166 that contains a dual-shaft shredding device 1168 having a pair of contra-rotating, intermeshing shredding rollers with suitable blades that can shred the plastic slurry using primarily shear forces. The plastic comminuting apparatus has an inlet to receive the washed plastic slurry 1118 and at least one outlet via which a size-reduced, secondary plastic stream 1122 (e.g. a plastic slurry in which the plastic and metal pieces have been subjected to a further size reduction and are smaller than in the plastic slurry exiting the primary comminuting apparatus 1102) can be extracted. The plastic comminuting apparatus 1120 can be controlled by any suitable controller 1170, which could include a computer, PLC or other such device.

As noted herein, unlike the primary comminuting apparatus 1102, the plastic comminuting apparatus 1120 is not configured to hold an immersion liquid or to submerge the shredding device 1168. Instead, the plastic comminuting apparatus 1120 includes an optionally spraying system 1172 that can spray a liquid onto the shredding blades and/or incoming material while the apparatus 1120 is in use (to help reduce dust, dissipate heat, inhibit off-gassing etc.).

Processing the primary plastic slurry via the plastic comminuting apparatus 1120 can produce the secondary, size-reduced plastic slurry 1122 that is extracted from the apparatus 1120. In addition to relatively smaller plastic and metal pieces, the size-reduced plastic slurry may also include electrolyte, black mass materials that was separated from the plastic and metal pieces via the shredding and may also include newly released electrolyte, black mass materials that is liberated when any partially or completely intact battery cells were ruptured by the plastic comminuting apparatus 1120 (i.e. having not been ruptured via the primary comminuting apparatus 1102).

Having been processed through the plastic comminuting apparatus 1120, the size-reduced, secondary plastic stream 1122 is conveyed to a separator 1124 that is downstream from the plastic comminuting apparatus 1120 to help separate the smaller plastic pieces from the metal pieces, black mass and electrolyte materials that are mixed within the sized-reduced plastic slurry 1122. In this example, the separator 1124 includes a separator tank 1174 that can receive the size-reduced plastic slurry 1122. The separator tank 1174 can hold a suitable liquid, such as the immersion liquid, water, the liquid used to spray the interior of the plastic comminuting apparatus 1120 or other suitable composition.

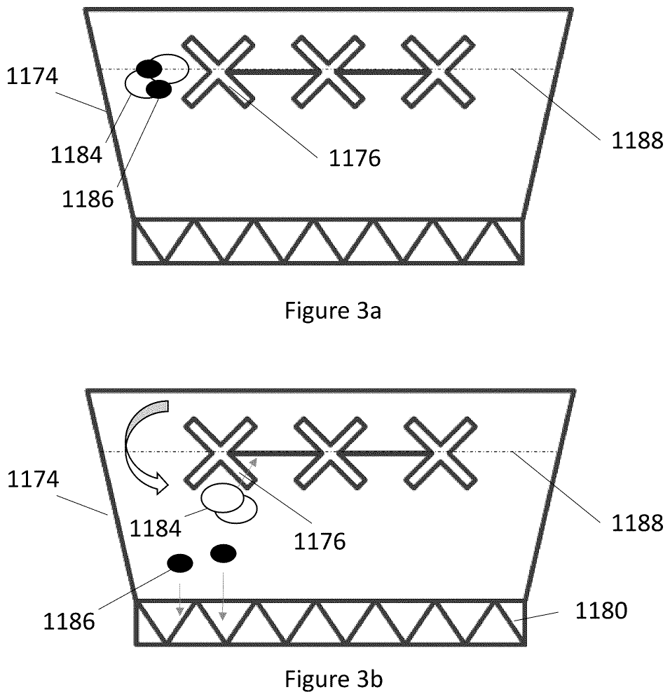

As the size-reduced plastic slurry enters the separator tank 1174 heavy material, like the metal pieces, may tend to sink while the lighter plastic may remain on the surface. In this example, the separator tank 1174 is shown schematically with three mechanical agitators in the form of rotatable submersion baffles or agitators 1176 that are positioned to engage the material floating on the surface of the liquid within the separator tank 1174 to agitate and optionally re-submerge the floating material as it travels along the tank 1174. This may help dislodge embedded metal material and/or to help wash off any adhering black mass and/or electrolyte materials. For example, referring also to FIGS. 3a and 3b, the secondary plastic stream may be a slurry that can include a mixed combination of plastic pieces 1184 and metal pieces 1186, which when mixed may float along the surface 1188 of the liquid within the tank 1174. The agitators 1176 are positioned at about the surface level of the liquid so that the baffles 1176 can mechanically impact and engage the pieces 1184 and 1186, which may help separate them. Also, the rotation of the agitators 1176 in this example (counter-clockwise as illustrated between FIGS. 3a and 3b) can drive the pieces 1184 and 1186 under the surface of the liquid. In this configuration, gravity may tend to pull the relatively dense metal pieces 1186 down toward the bottom of the tank for extraction, while the buoyancy forces acting on the plastic pieces 1184 may urge them back toward the surface 1188. While shown as rotatable members, in other examples the agitators may be moveable but need not be rotatable, and may pivot, translate, oscillate or otherwise move to help engage the materials in the tank.

The separator 1124 includes a weir 1178 at its downstream end that the floating plastic material can pass over to exit the tank 1174, thereby providing the relatively purer/cleaner stream of separated plastic material 1126. A metals outlet is provided toward the bottom of the tank 1174 and includes a screw conveyor 1180 that can receive the separated metals and other non-plastic materials to provide the metals stream 1128. The metals stream 1128 may be subjected to any desired processing to help recover any target metals and/or black mass material that was separate from the size-reduced plastic slurry via the separator 1124.

Optionally, the separated plastic material 1126 exiting the separator 1124 can be subjected to a second washing/screening process using a post-wash apparatus 1130. In this example the a post-wash apparatus 1130 is substantially the same as the pre-wash apparatus 1114 and includes a screen 1182 where the separated plastic material 1126 can be sprayed with a suitable liquid, via a sprayer 1184, to help remove remaining black mass, electrolyte or other material that may have remained on the separated plastic material 1126 when it exited the separator 1124. The output plastic material 1132 exiting the post-wash apparatus 1130 can exit the plastic circuit and can be collected and packaged for sale or subjected to further processing.

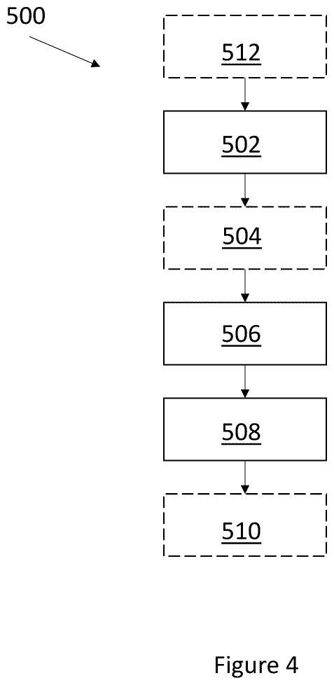

Referring to FIG. 4, a flow chart illustrates one example of a method 500 of separating plastic material from battery materials that can be exemplified by the systems 100 and 1100 described herein. The method 500 can include, at step 502 receiving an incoming plastic recovery stream (such as stream 104) that includes a primary plastic slurry with a mixture of plastic, metal, black mass and other components that have been liberated from battery materials. Optional step 504 is a pre-washing step in which the incoming plastic recovery stream is washed using any suitable apparatus (such as apparatus 1140) to help remove some of the black mass, electrolyte and other dissolved or relatively small particles—thereby producing a washed plastic slurry (such as slurry 118).

At step 506 the washed plastic slurry is subjected to a non-immersion, second size reduction process, for example using the plastic comminuting device 120, to further reduce the size of the pieces of plastic in the washed slurry, as well as to further reduce the size of any remaining metal pieces and to shred/break any intact or partially intact battery cells or other such components that were contained in the plastic recover stream 104. This step can produce a secondary plastics slurry.

Having reduced the size of the pieces in the stream, the method continues at step 508 with separating the size-reduced plastic pieces from the size-reduced metal pieces, and any newly liberated black mass, electrolyte and the like that was released via the plastic comminuting device. This step 508 can be conducted by treating the secondary plastics slurry using a suitable separator, such as separator 124 and 1124). The plastic pieces can be removed from the separator as relatively purer plastics stream, while the metal pieces and other contaminants can be separately removed from the separator.

An optional post-washing process can be conducted on the relatively purer plastics stream at optional step 510, using any suitable washing apparatus and/or screen, including those described herein. This can produce an output plastic material exiting the post-wash apparatus that can then exit the plastic circuit and be collected and packaged for sale or further processing.

Optionally, the method can also include the step 512 of receiving incoming battery materials and performing a first or initial size reduction on the battery materials under immersion conditions using a suitable, primary comminuting apparatus, to break down the battery materials, liberate the internal metals and black mass material and to break pieces of plastic off of the battery packs and other housing/packaging materials, and then extracting a plastic recovery stream that includes plastic pieces along with some of the immersion liquid, some black mass and electrolyte and entrained metal pieces.

For the purposes of describing operating ranges and other such parameters herein the phrase “about” means a difference from the stated values or ranges that does not make a material difference in the operation of the systems and processes described herein, including differences that would be understood a person of skill in the relevant art as not having a material impact on the present teachings. For pressures and temperatures about may, in some examples, mean plus or minus 10% of the stated value but is not limited to exactly 10% or less in all situations.

All publications, patents, and patent applications referred to herein are incorporated by reference in their entirety to the same extent as if each individual publication, patent, or patent application was specifically and individually indicated to be incorporated by reference in its entirety. It is understood that the teachings of the present application are exemplary embodiments and that other embodiments may vary from those described. Such variations are not to be regarded as a departure from the spirit and scope of the teachings and may be included within the scope of the following claims.

We claim:

1. A method of separating plastic material from battery materials comprising the plastic material, the process comprising the steps of:
a) receiving battery materials in an immersion comminuting apparatus comprising at least a first comminuting device submerged in an immersion liquid;
b) by carrying out at least a first size reduction of the battery materials under immersion conditions using the immersion comminuting apparatus thereby creating primary-reduced metal material, primary-reduced plastic material and liberating a first amount of a black mass material comprising anode and cathode powders from the battery materials, whereby sparking caused by the first size reduction is suppressed and heat generated by the first size reduction is absorbed by the immersion liquid;
c) extracting at least a primary plastics slurry from the primary comminuting apparatus, wherein the primary plastics slurry comprises a mixture of the primary-reduced plastic material, a portion of the primary-reduced metal material and a portion of the black mass material liberated by the immersion comminuting apparatus;
d) carrying out a further, second size reduction of the primary plastics slurry using a non-immersion comminuting apparatus that is downstream from the immersion comminuting apparatus and comprises at least a first non-submerged comminuting device, thereby creating at least secondary-reduced metal material and secondary-reduced plastic material; and
e) extracting a secondary plastic stream from the non-immersion comminuting apparatus, the secondary plastic stream comprising the secondary-reduced metal material and secondary-reduced plastic material.

2. The method of claim 1, further comprising spraying the first non-submerged comminuting device with a spray liquid while conducting the second size reduction, whereby the second size reduction is carried out under wet, but non-submerged conditions.

3. The method of claim 2, whereby sparking caused by the second size reduction is suppressed and heat generated by the second size reduction is absorbed by the spray liquid.

4. The method of claim 3, wherein the spray liquid comprises at least one of sodium hydroxide, calcium hydroxide, lithium hydroxide and the immersion liquid.

5. The method of any one of claims 1 to 4, wherein the primary plastic slurry comprises at least partially intact battery materials that did not pass through the first comminuting device, and wherein the second size reduction liberates a second amount of the black mass material from the at least partially intact battery materials in the primary plastic slurry.

6. The method of claim 5, wherein the secondary plastic stream comprises the black mass material liberated by the non-immersion comminuting apparatus.

7. The method of any one of claims 1 to 6, further comprising processing the secondary plastic stream to separate at least some of the secondary-reduced plastic material from the secondary-reduced metal material and black mass material remaining in the secondary plastic stream using a plastic separator, thereby producing separated plastic material.

8. The method of claim 7, wherein the plastic separator comprises a separator tank containing a liquid configured for floating the secondary-reduced plastic material and allowing the secondary-reduced metal material to and black mass material remaining in the secondary plastic stream precipitate.

9. The method of claim 8, wherein the separator tank comprises at least one movable, submersion agitator configured to contact and temporarily submerge portions of the secondary plastic stream floating on the liquid in the separator tank to enhance precipitation of the secondary-reduced metal material and the black mass material remaining in the secondary plastic stream.

10. The method of any one of claims 7 to 9, further comprising post-washing the separated plastic material exiting the plastic separator using a post-wash apparatus downstream from the plastic separator to remove black mass material that remained on the secondary-reduced plastic material when it exited plastic separator.

11. The method of any one of claims 1 to 10, further comprising pre-washing the primary plastics slurry exiting the immersion comminuting apparatus, using a pre-washing apparatus disposed between the immersion comminuting apparatus and the non-immersion comminuting apparatus, to separate at least some of the black mass material from the size-reduced plastic pieces before the plastic slurry reaches the non-immersion comminuting apparatus.

12. The method of claim 11, wherein the pre-washing apparatus comprises a solid/liquid separator.

13. The method of any one of claims 1 to 11, wherein the second size reduction is carried out at substantially atmospheric pressure and at less than 70 deg. C.

14. The method of any one of claims 1 to 13, wherein the first size reduction is carried out when the immersion liquid is at an operating temperature that is less than 70 degrees C.

15. The method of any one of claims 1 to 14, wherein the immersion liquid comprises at least one of sodium hydroxide, calcium hydroxide, and lithium hydroxide.

16. The method of any one of claims 1 to 15, wherein the first size reduction is carried out when the immersion liquid is at substantially atmospheric pressure.

17. The method of any one of claims 1 to 16, wherein at least some of the battery materials received in step 1a) are in at least a partially charged state.

18. The method of any one of claims 1 to 17, further comprising extracting a metals outlet stream from the immersion comminuting apparatus, wherein the metals outlet stream comprises a majority of the black mass material liberated by the immersion comminuting apparatus.

19. A system for recovering plastic material from battery materials, the system comprising:
a) an immersion comminuting apparatus comprising at least a first comminuting device submerged in an immersion liquid configured to carry out at least a first size reduction of the battery materials under immersion conditions thereby creating primary-reduced metal material, primary-reduced plastic material and liberating a first amount of a black mass material comprising anode and cathode powders from the battery materials, whereby sparking caused by the first size reduction is suppressed and heat generated by the size reduction is absorbed by the immersion liquid;
b) a plastic recovery stream exiting a plastic outlet of the first communising device and comprising a primary plastics slurry that includes a mixture of the size-reduced plastic material, a portion of the primary-reduced metal material and a portion of the black mass material liberated by the immersion comminuting apparatus; and
c) a non-immersion comminuting apparatus comprising at least a first non-submerged comminuting device disposed downstream from the immersion comminuting apparatus to receive a primary plastics slurry, the non-immersion comminuting apparatus configured to carry out a second size reduction on the primary plastics slurry, thereby creating at least secondary-reduced metal material and secondary-reduced plastic material;
wherein a secondary plastic stream exiting the non-immersion comminuting apparatus comprises the secondary-reduced metal material, secondary-reduced plastic material.

20. The system of claim 19, wherein the non-immersion comminuting apparatus comprises a spraying apparatus configured to spray the first non-submerged comminuting device with a spray liquid while conducting the second size reduction, whereby the second size reduction is carried out under wet, but non-submerged conditions.

21. The system of 20, wherein sparking caused by the second size reduction is suppressed and heat generated by the second size reduction is absorbed by the spray liquid.

22. The system of 20, wherein the spray liquid comprises at least one of sodium hydroxide, calcium hydroxide, lithium hydroxide and the immersion liquid.

23. The system of any one of claims 19 to 22, wherein the primary plastic slurry comprises at least partially intact battery materials that did not pass through the first comminuting device, and wherein the second size reduction liberates a second amount of the black mass material from the at least partially intact battery materials in the primary plastic slurry.

24. The system of claim 23, wherein the secondary plastic stream comprises the black mass material liberated by the non-immersion comminuting apparatus.

25. The system of any one of claims 19 to 24, further comprising a plastic separator fluidly connected downstream from the non-immersion comminuting apparatus and configured to process the secondary plastic stream to separate at least some of the secondary-reduced plastic material from the secondary-reduced metal material and black mass material remaining in the secondary plastic stream using, thereby producing separated plastic material.

26. The system of claim 25, wherein the plastic separator comprises a separator tank containing a liquid configured for floating the secondary-reduced plastic material and allowing the secondary-reduced metal material to and black mass material remaining in the secondary plastic stream precipitate.

27. The system of claim 26, wherein the separator tank comprises at least one movable, submersion agitator configured to contact and temporarily submerge portions of the secondary plastic stream floating on the liquid in the separator tank to enhance precipitation of the secondary-reduced metal material and the black mass material remaining in the secondary plastic stream.

28. The system of any one of claims 25 to 27, further comprising post-washing the separated plastic material exiting the plastic separator using a post-wash apparatus downstream from the plastic separator to remove black mass material that remained on the secondary-reduced plastic material when it exited plastic separator.

29. The system of any one of claims 19 to 28, further comprising using a pre-washing apparatus fluidly connected between the immersion comminuting apparatus and the non-immersion comminuting apparatus, the pre-washing apparatus configured to receive the primary plastics slurry exiting the immersion comminuting apparatus and to separate at least some of the black mass material from the size-reduced plastic pieces before the plastic slurry reaches the non-immersion comminuting apparatus.

30. The system of claim 29, wherein the pre-washing apparatus comprises a solid/liquid separator.

31. The system of any one of claims 19 to 30, wherein the second size reduction is carried out at substantially atmospheric pressure and at less than 70 deg. C.

32. The system of any one of claims 19 to 31, wherein the first size reduction is carried out when the immersion liquid is at an operating temperature that is less than 70 degrees C.

33. The system of any one of claims 19 to 32, wherein the immersion liquid comprises at least one of sodium hydroxide and calcium hydroxide.

34. The system of any one of claims 19 to 33, wherein the first size reduction is carried out when the immersion liquid is at substantially atmospheric pressure.

35. The system of any one of claims 19 to 34, wherein at least some of the battery materials processed by the immersion comminuting apparatus are in at least a partially charged state.

36. The system of any one of claims 19 to 35, wherein the immersion comminuting apparatus further comprises a metals outlet through which a metals outlet stream comprising a majority of the black mass material liberated by the immersion comminuting apparatus exits the immersion comminuting apparatus.
